(19) United States
(12) Patent Application Publication
(10) Pub. No.: US 2021/0078236 A1
(43) Pub. Date: Mar. 18, 2021

(54) METHOD OF MANUFACTURING A PLASTIC TANK

(71) Applicant: MAGNA Energy Storage Systems GesmbH, Sinabelkirchen (AT)

(72) Inventor: Harald HUMENBERGER, St. Ruprecht (AT)

(21) Appl. No.: 17/060,438

(22) Filed: Oct. 1, 2020

(30) Foreign Application Priority Data
Sep. 18, 2019 (EP) 19209704.6

(51) Int. Cl. B29C 49/20; B29C 65/00

(52) U.S. Cl. CPC B29C 49/20; B29K 2023/065; B29C 66/71

(57) ABSTRACT

A method of producing a plastic tank includes preparing a tank wall as a hot semi-finished sheet, in which at least one outer layer of the hot semi-finished sheet is composed of a first material. A reinforcing sheet, composed at least partially of the first material, is then attached to at least one region of the outer layer of the hot semi-finished sheet via a weld connection. The hot semi-finished sheet with the attached reinforcing sheet is then shaped to form the tank wall while simultaneously enhancing the attachment of the reinforcing sheet to the tank wall.

### CROSS-REFERENCE TO RELATED APPLICATIONS

The present application claims priority 35 U.S.C. § 119 to European Patent Publication No. EP 19209704.6 (filed on Nov. 18, 2019), which is hereby incorporated by reference in its entirety.

### TECHNICAL FIELD

Embodiments relate to a method for producing a plastic tank.

### BACKGROUND

It is known that plastic tanks, which in recent times have been installed, for example, as fuel tanks of motor vehicles, such as passenger cars and heavy goods vehicles, in addition to having a number of positive characteristics, are problematic in respect of possible deformations of the fuel tank. During the normal operation of tank systems in motor vehicles, large deformations can occur in certain zones of the tank system. Combinations of pressure and temperature peaks in zones of the tank can cause large relative movements of the tank shells, especially in the case of plastic tanks, and these must be limited by design measures.

Contemporary supporting concepts for reducing the unwanted deformations of the fuel tanks usually use points of support fixed with respect to the body to limit deformations of the tank walls. Particularly for pressurized tank systems, however, these measures are not sufficient, and additional measures must be employed to reduce deformations. Often, the shell thickness of the tank bladder is increased, or reinforcing components are secured on the tank wall to limit deformation. However, the attachment of reinforcing components to a tank wall has hitherto been time-consuming and expensive and lacking in flexibility in respect of the feasible component geometries for reinforcement.

### SUMMARY

Embodiments relate to a method for producing a plastic tank that is protected from deformations. At the same time, the method should be flexible in respect of reinforcement geometries, and should be possible to carry out in a particularly efficient manner.

In accordance with embodiments, a method for producing a plastic tank, wherein at least one outer layer of the tank wall of the plastic tank is composed of a first material, wherein a reinforcing sheet, which is composed at least partially of the first material, is attached to an outer layer of the tank wall of the plastic tank in at least one region, wherein first of all the tank wall is prepared as a hot semi-finished sheet, wherein the reinforcing sheet is secured, and particularly, welded, on the hot semi-finished sheet outside a shaping tool, wherein the semi-finished sheet is then introduced with the secured reinforcing sheet into the shaping tool, and is shaped in the shaping tool to form the tank wall of the plastic tank, whereby the reinforcing sheet is secured more strongly on the tank wall, and particularly, welded more strongly to the tank wall.

In accordance with embodiments, a reinforcing sheet is applied to a tank wall as a reinforcing element, wherein application takes place in two stages: first of all, the reinforcing sheet is secured only lightly outside a shaping tool. Since the reinforcing sheet is composed at least partially of the same material as the tank wall, and particularly, of the same plastic, or comprises the same plastic, it is, and particularly, a simple matter for the reinforcing sheet to be pressed onto the tank wall, with the result that the reinforcing sheet is melted or welded onto the hot tank wall. The same tank wall, with the reinforcing sheet, also referred to as a “patch,” attached, is then shaped to the final shape of the plastic tank in a shaping tool, wherein the reinforcing sheet is secured even more strongly on the tank wall or welded thereto or more strongly fused thereto.

In accordance with embodiments, through the introduction of the patch or reinforcing sheet outside the forming tool, the reproducible complexity of the surface geometry of the reinforcing sheet and the achievable degrees of forming are very high.

As used herein, the term “outer layer” refers to a tank wall layer situated on the outside and may be on the inside or the outside of the tank in the case of a fully formed plastic tank.

In accordance with embodiments, the tank wall is preferably of multilayer or multi-ply construction, but may also comprise a single layer.

In accordance with embodiments, the reinforcing sheet is preferably composed of a fibre-reinforced plastic, wherein the fibre reinforcement is embedded into a matrix and the matrix is composed of the first material. The first material is preferably high-density polyethylene (HDPE). As a particular preference, the reinforcing sheet is a woven glass fibre structure.

The hot semi-finished sheet is preferably held by a holding device, and particularly, via a vacuum, while the reinforcing sheet is secured on the semi-finished sheet outside the shaping tool. Outside the shaping tool, the reinforcing sheet is preferably secured on the semi-finished sheet via an extendable ram.

The ram can hold the reinforcing sheet via a vacuum. The vacuum is preferably ended when the reinforcing sheet has been secured on the hot semi-finished sheet. The ram is then removed from the semi-finished sheet again, and particularly, retracted.

The surface of the ram is inclined relative to an envisaged neutral position of the semi-finished sheet. By this means, sagging of the hot semi-finished sheet can be compensated, and the reinforcing sheet is applied parallel to the relevant portion of the semi-finished sheet.

The ram is preferably pressed into the hot semi-finished sheet in a force- or path-controlled manner in order to secure the reinforcing sheet on the hot semi-finished sheet outside the shaping tool.

The hot semi-finished sheet can be trimmed in a cutting tool, and particularly, before the hot semi-finished sheet is made available for securing the reinforcing sheet.

The semi-finished sheet is preferably shaped to form the tank wall of the plastic tank by deep drawing in the shaping tool, and particularly, via a vacuum.

Developments of the invention are specified in the dependent claims, the description and the appended drawings.

### DRAWINGS

Embodiments will be illustrated by way of example in the drawings and explained in the description hereinbelow.

FIG. 1 is a schematic illustration of a plastic tank produced, in accordance with embodiments.

FIG. 2 is a schematic illustration of a method for producing a plastic tank, in accordance with embodiments.

FIGS. 3A to 3C are schematic illustrations of the attachment of a reinforcing sheet in the method of FIG. 2.

FIGS. 4A and 4B are schematic detail illustrations of initial steps for the attachment of a reinforcing sheet in the method of FIG. 2.

FIGS. 5A and 5B are schematic detail illustrations of second steps for the attachment of a reinforcing sheet in the method of FIG. 2.

### DESCRIPTION

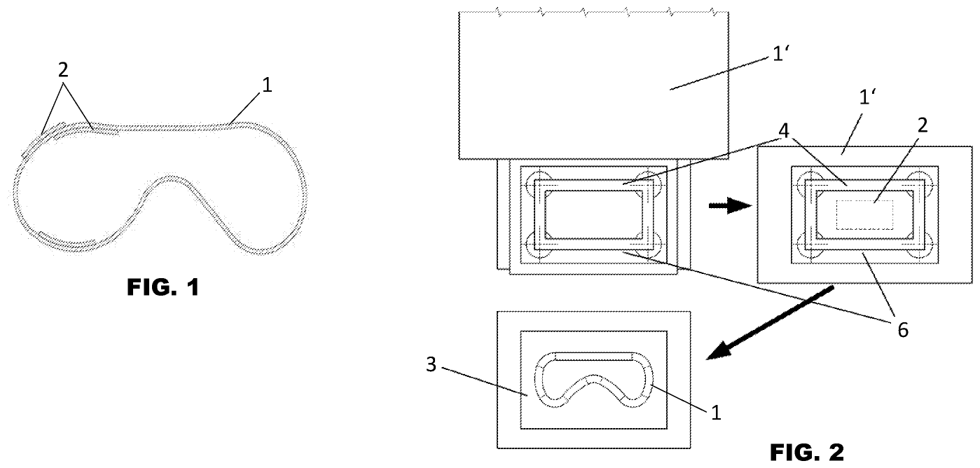

The local deformation of a tank shell is to be reduced by attaching structural components, i.e. reinforcing sheets 2, and particularly, fibre-reinforced structural components. For this purpose, these reinforcing sheets 2, structural components or patches can be attached inside and/or outside the tank. FIG. 1 shows a plastic tank of this kind, wherein the tank wall 1 of the plastic tank is partially reinforced by attaching reinforcing sheets 2 or patches in various regions. At least an outer layer of the tank wall 1 of the plastic tank is composed of HDPE. A reinforcing sheet 2, which is composed at least partially of the same material HDPE, is attached in several regions to the outer layer of the tank wall 1 of the plastic tank. The reinforcing sheets 2 are composed of a fibre-reinforced plastic, wherein the fibre reinforcement is embedded into a matrix and wherein the matrix is composed of the high-density polyethylene.

To produce a plastic tank of this kind, as illustrated schematically in FIG. 2, the tank wall 1 is first of all prepared as a hot semi-finished sheet 1′, wherein the semi-finished sheet 1′ may initially be an untrimmed, e.g. continuous, multilayer sheet.

The hot semi-finished sheet 1′ is trimmed in a cutting tool 6 and then made available for securing the reinforcing sheets 2 thereon.

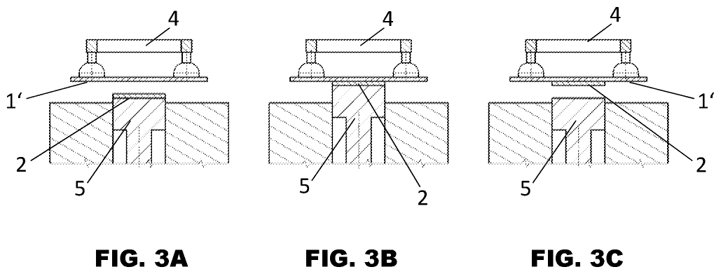

Outside a shaping tool 3, in which the shape of the tank shell is subsequently formed, the reinforcing sheets 2 are secured on the hot semi-finished sheet 1′, and particularly, melted on, as illustrated in greater detail in FIGS. 3 to 5.

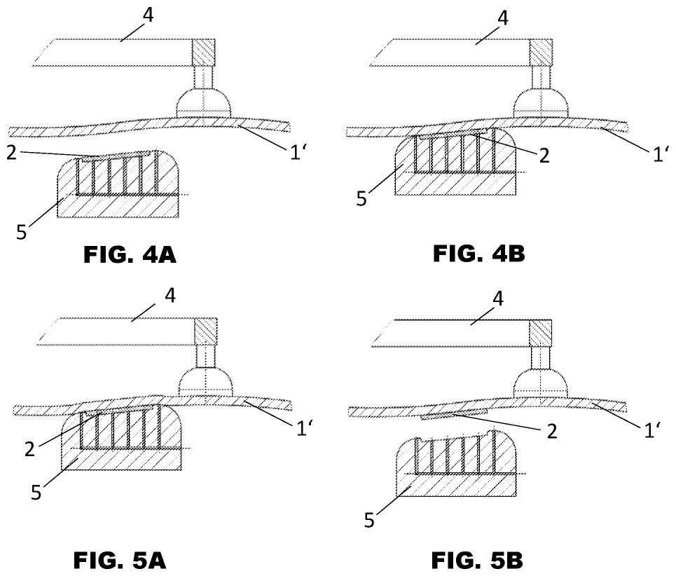

It is readily apparent in FIGS. 3 to 5 that the hot semi-finished sheet 1′ is held by a holding device 4, and particularly, via a vacuum, while the reinforcing sheet 2 is secured on the semi-finished sheet 1′ outside the shaping tool 3. The semi-finished sheet 1′ can be held from above, allowing it to hang downwards, as can be seen in the detail illustrations in FIGS. 4 and 5.

Outside the shaping tool 3, the reinforcing sheet 2 is secured on the semi-finished sheet 1′ via an extendable ram 5.

The semi-finished sheet 1′, with the secured reinforcing sheets 2, is then introduced into the shaping tool 3 and is shaped to form the tank wall 1 of the plastic tank in the shaping tool 3, whereby the reinforcing sheets 2 are secured more strongly on the tank wall 1, namely fused or welded more strongly to the tank wall 1.

The semi-finished sheet 1′ is shaped to form the tank wall 1 of the plastic tank by deep drawing in the shaping tool 3, and particularly, via a vacuum, thus preferably by vacuum deep drawing.

The method described is thus based on the positioning and fusing of the matrix material HDPE of the fibre patches or reinforcing sheets 2 to the HDPE outer layer material of the tank shell outside the shaping tool 3.

The fusing described takes place in a two-stage process. In a first step, the patch 2 is positioned at a defined location on the semi-finished sheet 1′ and is secured by bringing the semi-finished product 1′ and the fibre patch 2 into contact. Via the subsequent deep drawing process, permanent fusing of the two materials is brought about, and a permanent materially bonded connection is formed.

After the production of a hot multilayer sheet, said sheet is conveyed to the cutting and processing device 6. After the process of cutting the semi-finished sheet 1′ has been carried out, it is received in the holding device 4, and the semi-finished sheet 1′ is guided to a device for attaching the fibre patch 2. After the attachment of the fibre patch 2, the semi-finished sheet 1′ now reinforced with the fibre patch 2 is guided to the tool mould 3 and formed to its final form in the shaping process.

FIGS. 3A to 3C show schematically the attachment of the reinforcing sheets 2. The holding device 4 with the hot semi-finished sheet 1′ is moved into a precisely defined position above a ram 5. The fibre patch 2 is positioned on this ram 5 and is brought into contact with the hot sheet 1′ by being applied thereto. This can be a patch or reinforcing sheet 2 that is heated or is at room temperature.

FIGS. 4A and 4B show, in detailed diagrams, the securing of a reinforcing sheet 2 on a ram 5 and the positioning of the reinforcing sheet 2 or fibre patch on the semi-finished product 1′. The fibre patch 2 is held in position on the ram 5 by being subjected to a vacuum. This vacuum is preferably implemented via an encircling groove or by use of holes. During the application of the ram 5, the vacuum remains until positioning has been completed. The natural sag of the still partially plasticized multilayer material 1′ is compensated by a suitable inclination of the ram 5 relative to the neutral position of the semi-finished product 1′. Apart from the shape of the ram 5, this inclination can also be implemented by mounting via an articulated or ball joint of the ram 5.

FIGS. 5A and 5B show, in detailed diagrams, the securing of the reinforcing sheet 2 on the semi-finished sheet 1′, and the initial attachment process. To apply the necessary contact pressure, the ram 5 is pressed into the partially plasticized semi-finished sheet 1′ up to a certain end position in a force- or path-controlled manner. For this purpose, the edge regions of the ram 5 can be provided with a chamfer. The contact pressure of the glass fibre patch 2 on the semi-finished sheet 1′ can be additionally intensified via an encircling vacuum groove or encircling vacuum holes. During this process, the semi-finished sheet 1′ is additionally sucked against the surface of the ram 5 by the vacuum groove or vacuum holes. After a contact pressure time has expired, the vacuum for securing the patch 2 is deactivated, and the ram 5 moves back into the initial position without the fibre patch 2.

The semi-finished sheet 1′, which is now reinforced with the fibre patch or reinforcing sheet 2, is fed to the deep drawing process, in which a permanent materially bonded connection between the fibre patch 2 and the tank wall 1 that has now been formed is obtained through the application of a vacuum from the direction of the tool.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims

### LIST OF REFERENCE SYMBOLS

1 Tank wall
1′ Semi-finished sheet
2 Reinforcing sheet
3 Shaping tool
4 Holding device
5 Ram
6 Cutting tool

What is claimed is:

1. A method of producing a plastic tank, the method comprising:
preparing a tank wall as a hot semi-finished sheet, in which at least one outer layer of the hot semi-finished sheet is composed of a first material;
attaching a reinforcing sheet, composed at least partially of the first material, to at least one region of the outer layer of the hot semi-finished sheet via a weld connection;
introducing the attached reinforcing sheet and the hot semi-finished sheet into a shaping tool; and
shaping, via the shaping tool, the hot semi-finished sheet with the attached reinforcing sheet to form the tank wall, while simultaneously enhancing the attachment of the reinforcing sheet to the tank wall.

2. The method of claim 1, wherein the reinforcing sheet comprises a fibre-reinforced plastic embedded into a matrix composed of the first material.

3. The method of claim 2, wherein the first material comprises high-density polyethylene.

4. The method of claim 1, wherein attaching the reinforcing sheet comprises holding the hot semi-finished sheet by a holding device while the reinforcing sheet is attached to the hot semi-finished sheet via the weld connection.

5. The method of claim 1, wherein attaching the reinforcing sheet comprises attaching the reinforcing sheet on the hot semi-finished sheet via an extendable ram.

6. The method of claim 5, wherein, during the attachment of the reinforcing sheet, the extendable ram holds the reinforcing sheet via a vacuum, and releases the vacuum when the reinforcing sheet is attached to the hot semi-finished sheet.

7. The method of claim 5, wherein, during the attachment of the reinforcing sheet, the surface of the extendable ram is inclined relative to an envisaged neutral position of the hot semi-finished sheet.

8. The method of claim 5, wherein, during the attachment of the reinforcing sheet, the extendable ram is pressed into the hot semi-finished sheet in a force- or path-controlled manner in order to attach the reinforcing sheet on the hot semi-finished sheet.

9. The method of claim 1, further comprising, before attaching the reinforcing sheet, trimming the hot semi-finished sheet via a cutting tool.

10. The method of claim 1, wherein shaping the hot semi-finished sheet with the attached reinforcing sheet comprises deep drawing the hot semi-finished sheet with the attached reinforcing sheet via a vacuum.

11. A method for producing a plastic tank, the method comprising:
attaching, via a weld connection, a reinforcing sheet composed at least partially of a first material to at least one region of an outer layer of a hot semi-finished sheet composed of the first material; and
shaping, via a shaping tool, the hot semi-finished sheet with the attached reinforcing sheet to form the tank wall, while simultaneously enhancing the attachment of the reinforcing sheet to the tank wall.

12. The method of claim 11, wherein the first plastic material comprises high-density polyethylene.

13. The method of claim 11, wherein attaching the reinforcing sheet comprises holding the hot semi-finished sheet by a holding device while the reinforcing sheet is attached to the hot semi-finished sheet via the weld connection.

14. The method of claim 11, wherein attaching the reinforcing sheet comprises attaching the reinforcing sheet on the hot semi-finished sheet via an extendable ram.

15. The method of claim 14, wherein, during the attachment of the reinforcing sheet, the extendable ram holds the reinforcing sheet via a vacuum, and releases the vacuum when the reinforcing sheet is attached to the hot semi-finished sheet.

16. The method of claim 14, wherein, during the attachment of the reinforcing sheet, the surface of the extendable ram is inclined relative to an envisaged neutral position of the hot semi-finished sheet.

17. The method of claim 14, wherein, during the attachment of the reinforcing sheet, the extendable ram is pressed into the hot semi-finished sheet in a force- or path-controlled manner in order to attach the reinforcing sheet on the hot semi-finished sheet.

18. The method of claim 11, further comprising, before attaching the reinforcing sheet, trimming the hot semi-finished sheet via a cutting tool.

19. The method of claim 11, wherein shaping the hot semi-finished sheet with the attached reinforcing sheet comprises deep drawing the hot semi-finished sheet with the attached reinforcing sheet via a vacuum.

20. A method for producing a plastic tank, the method comprising:
attaching a reinforcing sheet composed at least partially of a first plastic material to at least one region of an outer layer of a hot semi-finished sheet composed of the first plastic material; and
shaping, via a vacuum, the hot semi-finished sheet with the attached reinforcing sheet to form the tank wall, while simultaneously enhancing the attachment of the reinforcing sheet to the tank wall via the vacuum.
